(19) United States
(12) Patent Application Publication
(10) Pub. No.: US 2017/0327219 A1
(43) Pub. Date: Nov. 16, 2017

(54) VERTICAL TAKE-OFF AND LANDING AIRCRAFT WITH HYBRID POWER AND METHOD

(71) Applicant: Sikorsky Aircraft Corporation, Stratford, CT (US)

(72) Inventor: Mark R. Alber, Milford, CT (US)

(21) Appl. No.: 15/369,270

(22) Filed: Dec. 5, 2016

Related U.S. Application Data
(60) Provisional application No. 62/266,552, filed on Dec. 11, 2015.

(51) Int. Cl. B64C 29/02; B64D 27/12; H02S 40/38; H01M 8/04082; H01M 10/46; H01M 8/04007; B64D 27/24; B64D 27/02

(52) U.S. Cl. CPC B64C 29/02; H01M 8/04007; B64D 27/12; B64D 27/24; H02S 40/38; H01M 8/04201; H01M 10/465; B64D 2211/00; B64D 2027/026; H01M 2250/20; H01M 2250/402; H01M 2250/407

(57) ABSTRACT

A vertical take-off and landing aircraft including a wing structure including a wing, a rotor operatively supported by the wing, and a hybrid power system configured to drive the rotor, the hybrid power system including a first power system and a second power system, wherein a first energy source for the first power system is different than a second energy source for the second power system.

### CROSS REFERENCE TO RELATED APPLICATIONS

This application claims the benefit of an earlier filing date from U.S. Provisional Application Ser. No. 62/266,552 filed Dec. 11, 2015, the entire disclosure of which is incorporated herein by reference.

### BACKGROUND

The subject matter disclosed herein relates generally to the field of rotorcraft, and more particularly to a vertical take-off and landing (VTOL) aircraft with a power system that balances and maximizes take-off and endurance performance.

Typically, a VTOL aircraft, such as a helicopter, tiltrotor, tiltwing, or a tail-sitter aircraft, can be airborne from a relatively confined space. Unmanned aerial vehicles (UAV's), for example, fixed-wing, and rotorcraft UAV's are powered aircraft without a human operator. Autonomous UAV's are a natural extension of UAV's and do not require real-time control by a human operator and may be required to operate over long distances during search and/or rescue operations or during intelligence, surveillance, and reconnaissance (ISR) operations. A UAV tail-sitter aircraft has a fuselage that is vertically disposed during take-off and hover and must transition from a vertical flight state (i.e., rotor borne) to a horizontal flight-state (i.e., wing borne). However, during take-off or hover, the VTOL aircraft requires more power from the engines than is required during long-range cruise (i.e., wing borne flight). Aircraft is designed to use the maximum rated power of all engines for takeoff or hover. However, operating both engines during cruise can negatively impact desirable endurance for the aircraft during ISR operations.

The need for long endurance is challenging especially when considering the need for operations from confined and unprepared surfaces. Stringent takeoff requirements required for VTOL air vehicles fundamentally usually sizes the air vehicle. Engine size, fuel consumption, air vehicle weight and its effective lift/drag (higher is better) all drive its endurance performance.

### BRIEF DESCRIPTION

A vertical take-off and landing aircraft includes a wing structure including a wing, a rotor operatively supported by the wing, and a hybrid power system configured to drive the rotor. The hybrid power system includes a first power system and a second power system. A first energy source for the first power system is different than a second energy source for the second power system.

In addition to one or more of the features described above or below, or as an alternative, further embodiments could include the first power system including a fuel cell.

In addition to one or more of the features described above or below, or as an alternative, further embodiments could include a fuselage substantially centrally disposed with respect to the wing structure, wherein the first energy source is liquid hydrogen and disposed at least partially in the fuselage.

In addition to one or more of the features described above or below, or as an alternative, further embodiments could include a nacelle disposed on the wing structure and supporting the rotor, wherein the fuel cell is disposed in the nacelle, and further including a fuel cell cooling system disposed in the nacelle.

In addition to one or more of the features described above or below, or as an alternative, further embodiments could include the second power system including a fuel-burning engine.

In addition to one or more of the features described above or below, or as an alternative, further embodiments could include the second energy source including fuel disposed in a fuel tank at least partially supported on the wing structure.

In addition to one or more of the features described above or below, or as an alternative, further embodiments could include the second power system including at least one solar panel disposed at least partially on the wing structure.

In addition to one or more of the features described above or below, or as an alternative, further embodiments could include a battery configured to store solar energy captured by the at least one solar panel.

In addition to one or more of the features described above or below, or as an alternative, further embodiments could include a fuselage substantially centrally located with respect to the wing structure, wherein the battery is disposed in the fuselage.

In addition to one or more of the features described above or below, or as an alternative, further embodiments could include a nacelle disposed on the wing structure and supporting the rotor, wherein the battery is disposed within the nacelle.

In addition to one or more of the features described above or below, or as an alternative, further embodiments could include a third power system, wherein a third energy source for the third power system is a different type of energy source than the first and second energy sources.

In addition to one or more of the features described above or below, or as an alternative, further embodiments could include the third power system including at least one solar panel disposed at least partially on the wing structure.

In addition to one or more of the features described above or below, or as an alternative, further embodiments could include the wing as a first wing, and the rotor as a first rotor, and further including a fuselage, a second wing, the first and second wings extending outwardly from opposite sides of the fuselage, a first nacelle supported on the first wing, the first rotor operatively configured on the first nacelle, a second nacelle supported on the second wing, and a second rotor operatively configured on the second nacelle.

In addition to one or more of the features described above or below, or as an alternative, further embodiments could include the first power system at least partially disposed in the first nacelle, the second power system at least partially disposed in the second nacelle, and at least one of the first and second energy sources at least partially disposed in the fuselage.

In addition to one or more of the features described above or below, or as an alternative, further embodiments could include a first gearbox of the first rotor, a second gearbox of the second rotor, and a cross-shaft connection between the first and second gearboxes, wherein, through the connection, power from the first power system is selectively transferrable to the first and second gearboxes and power from the second power system is selectively transferrable to the first and second gearboxes.

In addition to one or more of the features described above or below, or as an alternative, further embodiments could include a first motor of the first rotor, a second motor of the second rotor, and an electrical connection between the first and second motors, wherein, through the electrical connection, power from the first power system is selectively transferrable to the first and second motors, and power from the second power system is selectively transferrable to the first and second motors.

In addition to one or more of the features described above or below, or as an alternative, further embodiments could include a control system controlling the transfer of power from the first and second power systems to the first and second rotors, wherein each of the first and second power systems provide power to the first and second rotors during a first mode of operation, and only the first power system provides power to the first and second rotors during a second mode of operation.

A method of controlling a vertical take-off and landing aircraft, the aircraft including a fuselage, a wing structure, a first rotor, and a second rotor, includes determining whether the aircraft is operated in a first mode of operation requiring a first power demand or a second mode of operation requiring a second power demand lower than the first power demand; operating each of a first and second power system to provide power to the first and second rotors during the first mode of operation, wherein the first and second power systems access different types of energy sources; and, operating only the first power system to provide power to the first and second rotors during the second mode of operation.

In addition to one or more of the features described above or below, or as an alternative, further embodiments could include the first power system including a fuel cell, and the fuselage storing liquid hydrogen for the fuel cell.

In addition to one or more of the features described above or below, or as an alternative, further embodiments could include the energy sources including any combination of solar energy, fossil fuel, and liquid hydrogen.

A vertical take-off and landing aircraft includes a fuselage configured to store liquid hydrogen, first and second wings extending outwardly from opposite sides of the fuselage, a first nacelle supported on the first wing, a first rotor on the first nacelle, a second nacelle supported on the second wing, a second rotor on the second nacelle, and a power system including a fuel cell in receipt of liquid hydrogen, and a motor driven by the fuel cell and operatively arranged to drive the first and second rotors.

### BRIEF DESCRIPTION OF THE DRAWINGS

The subject matter that is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1A is a perspective view of an embodiment of an aircraft that is shown during take-off;

FIG. 1B is a perspective view of an embodiment of an aircraft that is shown during horizontal flight;

FIG. 2 is a schematic diagram of an embodiment of the aircraft with one embodiment of a hybrid power system;

FIG. 3 is a schematic diagram of an embodiment of the aircraft with another embodiment of a hybrid power system;

FIG. 4 is a schematic diagram of an embodiment of the aircraft with yet another embodiment of a hybrid power system; and,

FIG. 5 is a schematic diagram of an embodiment of the aircraft with still another embodiment of a hybrid power system.

### DETAILED DESCRIPTION

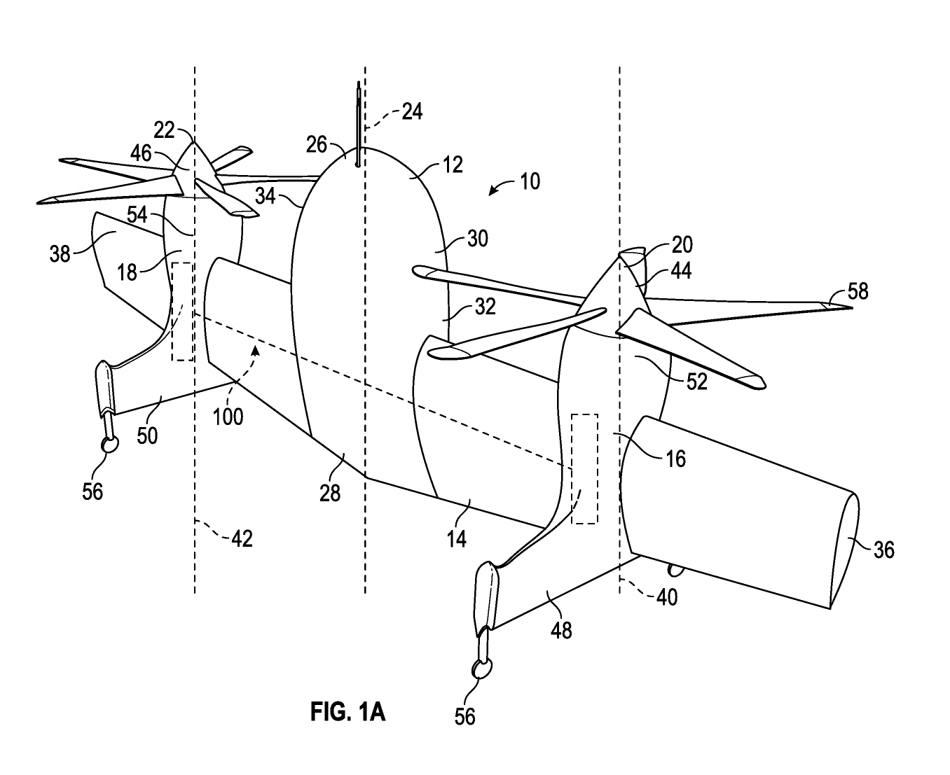

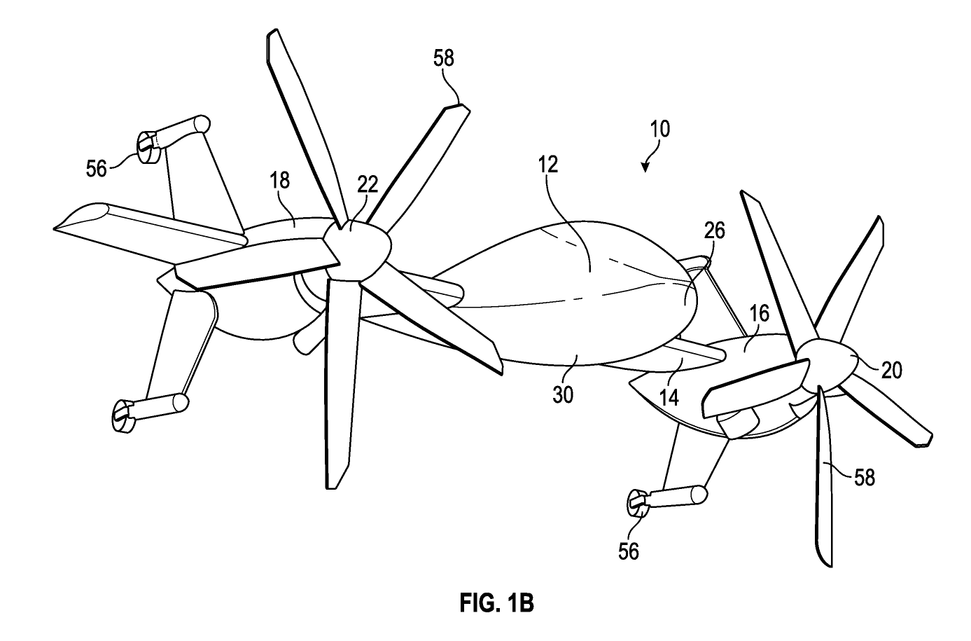

Referring now to the drawings, FIGS. 1A and 1B illustrate perspective views of an embodiment of a VTOL vehicle in the form of a tail-sitter aircraft 10 for providing high speed, and endurance flight. As illustrated, tail-sitter aircraft 10 includes a fuselage 12, an elongated wing structure 14, a plurality of nacelles 16, 18, and a plurality of rotors 20, 22. FIG. 1A shows an embodiment of the aircraft 10 as it may be orientated during take-off (or hover) in a rotor-borne flight state, where longitudinal axis 24 of fuselage 12 is oriented in a vertical direction and may be substantially perpendicular with respect to a ground plane. FIG. 1B shows an embodiment of the aircraft 10 during a cruise (wing-borne flight), where the wing structure 14 and fuselage 12 can be substantially parallel to the ground plane. The fuselage 12 is generally located in the middle of wing structure 14. The fuselage 12 may have an aerodynamic shape with a nose section 26, a trailing end 28 opposite from the nose section 26, and an airframe 30. The airframe 30 has first and second opposite sides 32, 34 and is formed and sized to encompass at least portions of an aircraft power system, as will be further described below. The wing structure 14 may include first and second wings 36, 38 that extend outwardly from the first and second opposite sides 32, 34 of the airframe 30, respectively. The plurality of nacelles 16, 18 and rotors 20, 22 are mounted to the wing structure 14 along respective axes 40, 42. Axes 40, 42 may be generally parallel to axis 24. The first and second nacelles 16, 18 are supported on each of the first and second wings 36, 38, such as, but not limited to, at about 40 to about 60% span locations, respectively. The first and second nacelles 16, 18 have an aerodynamic shape with forward sections 44, 46, trailing end portions 48, 50 opposite from the forward sections 44, 46, and nacelle frames 52, 54. The nacelle frames 52, 54 are also formed and sized to encompass portions of the aircraft power system 100, as will be further described below. Extendable landing gear 56 may extend from the nacelles 16, 18, with the landing gear 56 shown in the extended position for landing in FIG. 1A, and in the retracted position for forward flight in FIG. 1B. Each rotor 20, 22 includes rotor blades 58 disposed at the forward sections 44, 46 and rotatable about the axes 40, 42. The rotor blades 58 may further be controllable to pitch about respective pitch axes that run along their respective longitudinal lengths. The rotors 20, 22 provide thrust during take-off and hover (rotor borne flight state) and during cruise (wing borne flight). During cruise, wing structure 14 is configured to provide lift while the aircraft power system 100 provides power to rotate rotors 20, 22 and provide thrust during one or more operating modes of the aircraft 10.

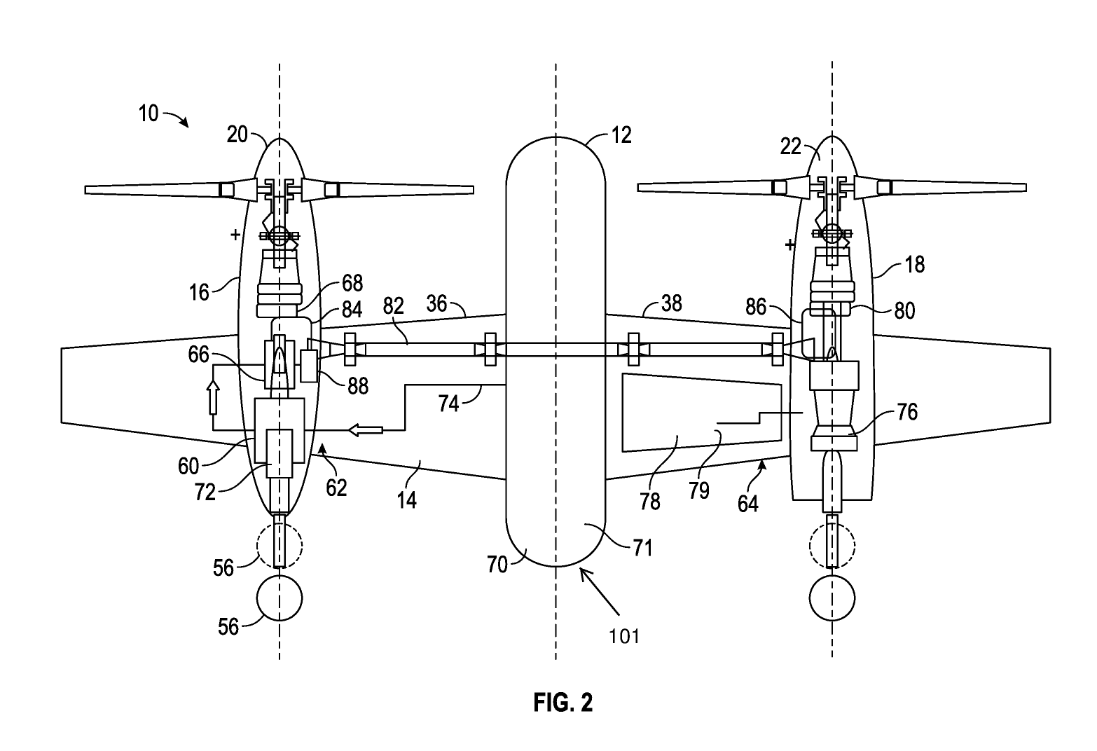

As will be further described below with additional reference to FIGS. 2-5, embodiments of the aircraft power system 100 include a fuel cell 60, where the fuel for the fuel cell 60 is provided in the fuselage 12. In some embodiments of the aircraft power system 100, such as a hybrid power system, the aircraft power system 100 includes a plurality of different types of power systems that provide the aircraft 10 with power during hover, high speed-cruise, and long endurance cruise for endurance operations. In embodiments described herein, the fuselage 12 and each nacelle 16, 18 respectively include at least a portion of the power systems. In one embodiment, first and second power systems are configured for control by a flight computer in order to provide maximum power during take-off and hover and reduced power for endurance flight. The first power system and second power system may combine to provide power during take-off and hover, while the first power system may provide power during forward flight. The first and second power systems can alternatively cooperate to provide 100 percent aircraft power required for hover and forward flight. In other embodiments, more than two different types of power systems may be incorporated within the aircraft power system 100. Also, features of embodiments described herein may be combined.

FIG. 2 schematically depicts an embodiment of the tail-sitter aircraft 10, which is a vertical take-off and landing (VTOL) aircraft. Landing gear 56 shown by solid lines demonstrates the landing gear 56 in the extended position, and landing gear 56 shown by the dashed lines demonstrates the landing gear 56 in the retracted position. The aircraft 10 uses a hybrid power system 101 including a first power system 62 and a second power system 64. Together, the first and second power systems 62, 64 can achieve stringent takeoff performance with improved endurance performance for the aircraft 10. The first power system 62 includes the fuel cell 60, which develops power to augment high power demand and provides efficient power for long endurance flight. The fuel cell 60 electrochemically combines hydrogen and oxygen to produce electricity, which drives a motor 66 connected to the gearbox 68, which in turn drives rotor 20. The fuel cell 60 uses liquid hydrogen stored at least partially in a liquid hydrogen tank 70 within fuselage 12. While described as disposed within the fuselage 12, additional or alternate liquid hydrogen tanks 70 may be provided along the wing structure 14 as needed. The first power system 62 further includes a fuel cell cooling system 72 to cool fuel cell 60. In the illustrated embodiment, the fuel cell 60 and the fuel cell cooling system 72 are provided in the first nacelle 16. Liquid hydrogen from the liquid hydrogen tank 70 is provided as a first energy source 71 to the fuel cell 60 from the fuselage 12 to the first nacelle 16 as indicated by line 74.

The second power system 64 includes an engine 76, such as an engine 76 that burns a fuel (a second energy source 79 that is a different type of energy source than the first energy source 71) stored in fuel tank 78 to develop power for high power demand conditions including hover, high speed cruise, climb and operate in conditions where redundant power is required. The engine 76 may be a turboshaft engine, however alternate embodiments of a prime mover that burns fuel may be incorporated. While fuel tank 78 is illustrated only on second wing 38 for clarity, it should be understood that one or more additional fuel tanks 78 may also be provided anywhere along the wing structure 14, including the first wing 36, for weight balance purposes of the aircraft 10. The input of the engine 76 mechanically drives gearbox 80, which turns the rotor 22 that is in the same nacelle 18.

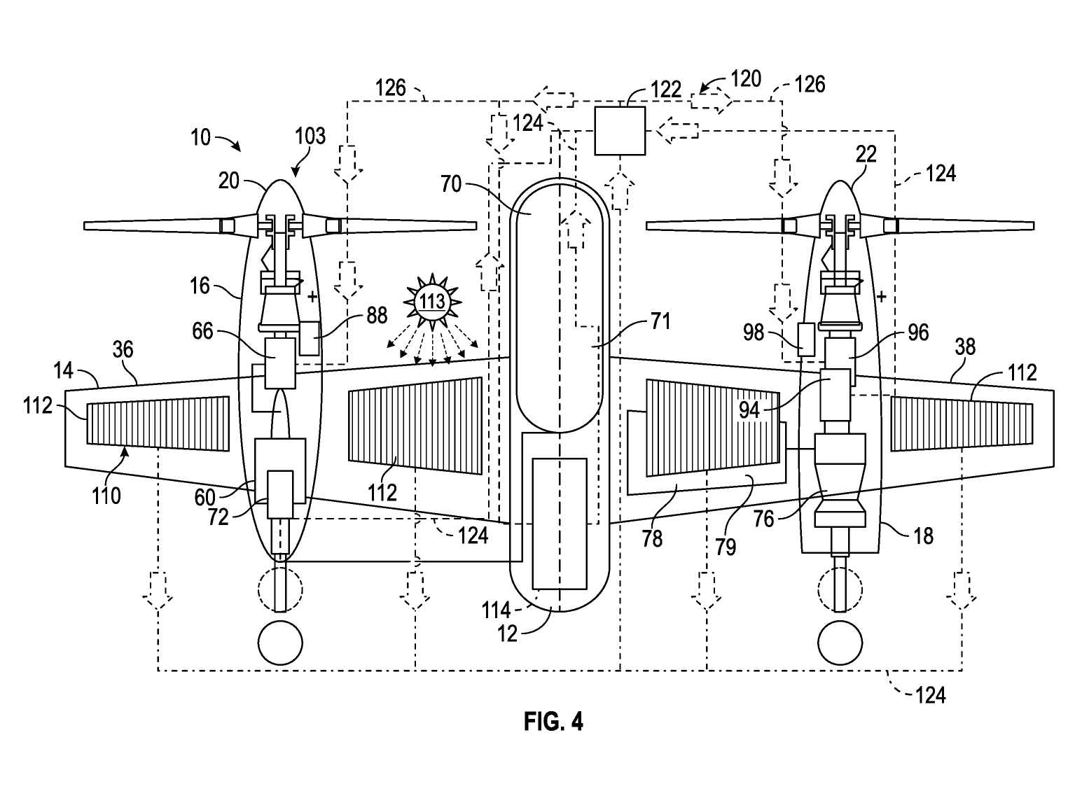

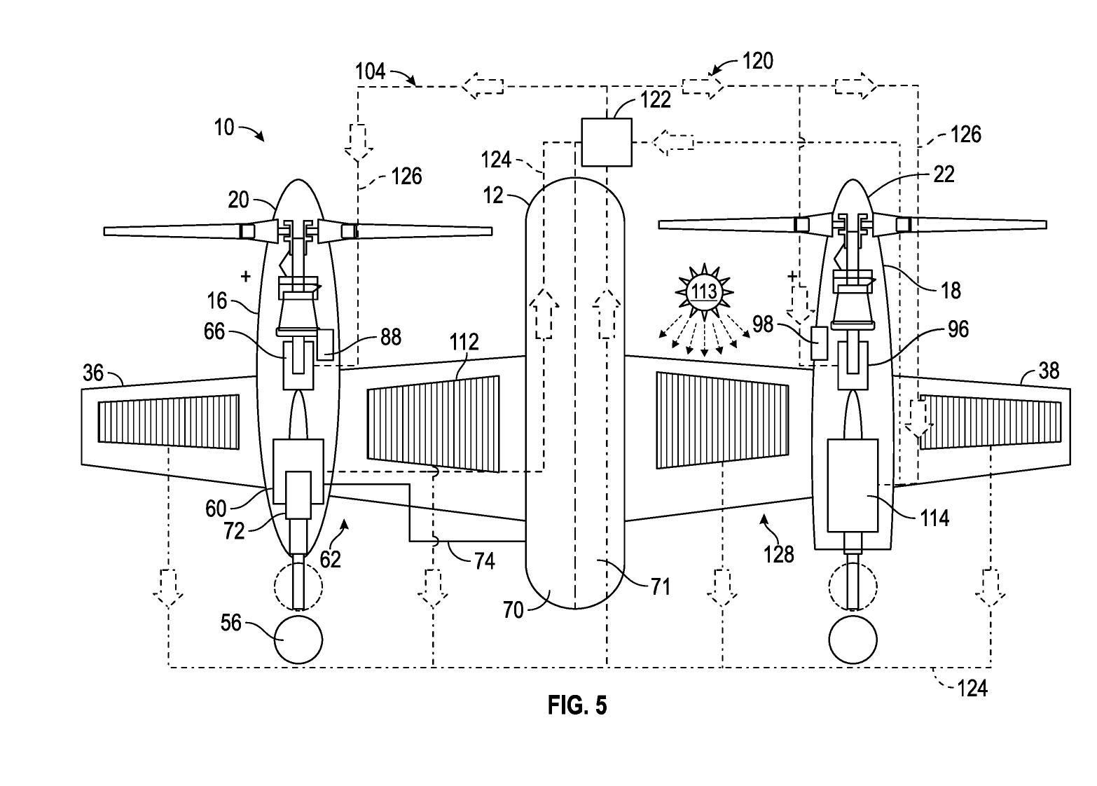

The gearbox 80 in nacelle 18 is connected to gearbox 68 in nacelle 16 to enable driving the rotor 20 (and rotor 22) using power from the second power system 64, and to drive rotor 22 (and rotor 20) using power from the first power system 62. In the illustrated embodiment of FIG. 2, the connection between the gearboxes 68, 80 includes a mechanical interconnection such as cross-shaft 82. A flight control system (including one or more controllers 122 as shown in FIGS. 4 and 5) selectively operates the first and second power systems 62, 64 independently or in combination to distribute the power from the first and second power systems 62, 64 as needed to the first and second rotors 20, 22. The control system, using redundant controllers, may drive a digital control system on the engine 76 and a controller 88 that drives the motor 66. Clutch 84, 86 respectively mechanically disconnects motor 66 and engine 76 from drive system to rotors 20, 22 when power is not required from one or both of the power systems 62, 64.

The aircraft power system 101 thus provides for operations in confined spaces and from unprepared surfaces. Performance benefits are achieved using a combination of both systems 62, 64, which access different types of energy sources 71, 79. In particular, the second power system 64 including the engine 76 develops power for high power demand: hover, high speed cruise, climb, and conditions where redundant power is required. First power system 62 including fuel cell 60 develops power to augment high power demand and provides efficient power for long endurance flight.

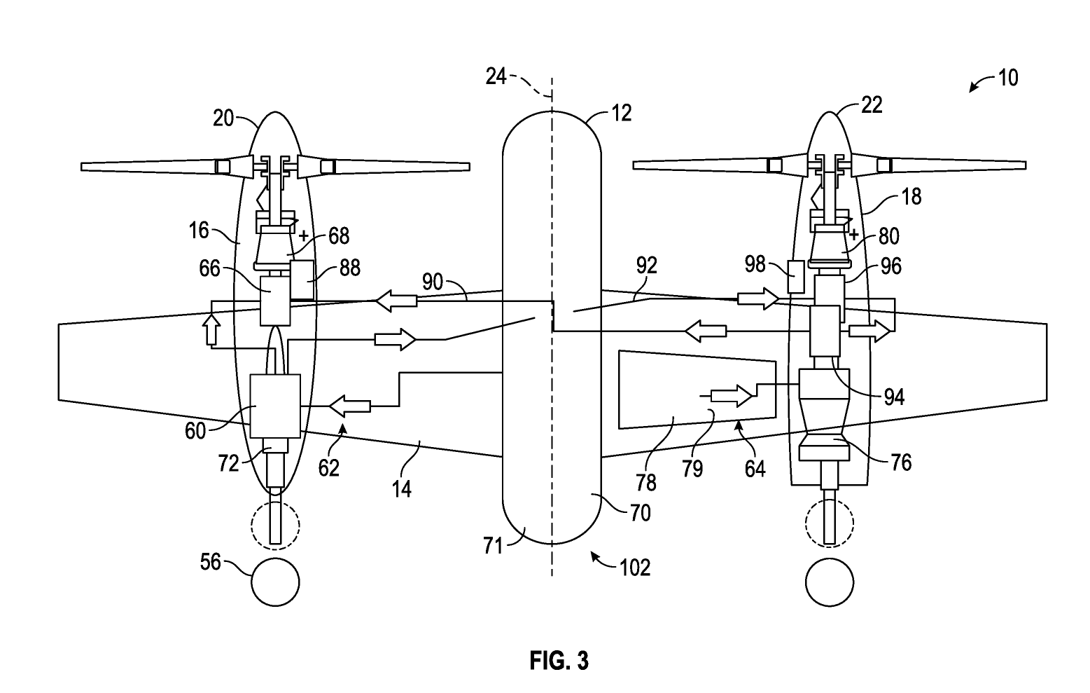

The embodiment of an aircraft power system 102 illustrated in FIG. 3 is similar to the aircraft power system 101 illustrated in FIG. 2, however the mechanical connection via cross-shaft 82 is replaced by electrical connections, represented by lines 90, 92. In the second power system 64, the engine 76 drives generator 94. The generator 94 converts mechanical energy to electrical energy to drive motor 96. Rotor 22 is driven by gearbox 80, which is driven by motor 96. Thus, electrical power is obtained from either the first power system 62 or the second power system 64, or both. The mechanical connection between power systems 62, 64 of FIG. 2 is removed, and electrically powered motors 66, 96 drive the rotor systems 20, 22 eliminating the need for a complex mechanical drive system. In addition to the first and second power systems 62, 64 respectively driving first and second rotors 20, 22, line 92 electrically connects the first power system 62 to the second motor 96, and line 90 electrically connects the second power system 64 to the first motor 66. First and second controllers 88, 98 are included in a control system (including one or more controllers as shown in FIGS. 4 and 5) that selectively operates the first and second power systems 62, 64 independently or in combination to distribute the power from the first and second power systems 62, 64 as needed to the first and second rotors 20, 22. Fuel cell 60 and engine 76 drive the motors 66, 96, while motors 66, 96 drive the rotors 20, 22. In an alternate embodiment, gearboxes, such as gearboxes 68, 80 may drive the rotors 20, 22.

The embodiment of an aircraft power system 103 depicted in FIG. 4 includes the same components as the aircraft power system 102 depicted in FIG. 3, but additionally includes a third power system 110 including one or more solar panels or cells 112, battery 114, and associated electrical connections. Solar energy is used as a third and alternate energy source 113 in the aircraft power system 103. Thus, the third energy source 113 is a different type of energy source than the first and second energy sources 71, 79. Solar cells 112 may be located on upward facing surfaces of the wing structure 14 when the aircraft 10 is in a cruise mode to create electricity. Solar cells 112 on wing structure 14 capture energy and either use the electricity immediately or store it within the battery 114. The battery 114 may be used as both a storage location for electric energy, and also as a source of electrical power that can drive the motors 66, 96. In the illustrated embodiment of FIG. 4, battery 114 is disposed in the fuselage 12 with tank 70, however the battery 114 may be alternatively located on the wing structure 14. The battery 114 may be any unit that stores energy over a specific time, such as, but not limited to, a lithium compound battery or other commercially available battery that meets the weight limitations and needs of the aircraft 10. Further, while only one battery 114 is shown, multiple batteries 114 may be provided and distributed about the aircraft 10 for weight balancing. The third power system 110 may enable use of solar energy directly as it is harnessed by the solar cells 112, or may allow some storage of energy within the battery 114 for darkness operations. Furthermore, battery 114 could be charged at takeoff so that the battery 114 is usable immediately as needed as a power source. One embodiment of a control system 120 for the aircraft power system 103 is schematically depicted in FIG. 4. The control system 120 includes at least one controller 122 that receives electrical power from the fuel cell 60, generator 94, solar cells 112, and battery 114, such as through incoming lines 124. The controller 122 (or redundant controllers 122) distribute electrical power for use to power motors 66, 96 as needed, and to the battery 114 for later use, such as through outgoing lines 126. The control system 120 further includes the motor controllers 88, 98, which may receive control signals from the controller 122 regarding operation of the motors 66, 96.

Thus, the aircraft 10, which uses a hybrid power system including the engine 76, fuel cell 60, solar cells 112 and a flight power battery 114, can achieve stringent takeoff performance with improved endurance performance. Solar cells 112 offer an additional electrical energy source. Battery 114 offers the opportunity to store energy for no/low light conditions. The solar energy from the solar cells 112 is directed to the controller 122, which in turn decides if the solar energy will be used as an instantaneous power source to run the motors 66, 96, or if it will be stored in the battery 114 (thus charging the battery 114). Engine 76 develops power for high power demand conditions including hover, high speed cruise, climb and operate in conditions where redundant power is required. Fuel cell 60 develops power to augment high power demand and provides efficient power for long endurance flight. Electrically powered motors 66, 96 drive the rotors 20, 22 eliminating the need for a complex mechanical drive system. High endurance is enabled using the fuel cell 60, solar panels 112, and battery 114 in a high lift to drag configuration (vs. conventional rotorcraft).

The embodiment of an aircraft power system 104 depicted in FIG. 5 includes the same components as the aircraft power system 103 depicted in FIG. 4, but totally takes engine 76 out of the system 104, thus leaving a purely electric hybrid aircraft 10. Also, in view of the removal of the second power system 64, the previously enumerated third power system 110 is now a second power system 128, however it should be understood that the designations of first, second, third, etc. is for distinguishing purposes only and does not indicate any particular order or importance unless otherwise defined herein. The battery 114 may fill the void left by the engine 76, however the battery 114 (or batteries 114) may alternatively be housed on the wing structure 14. In either case, more space is provided in the fuselage 12 for liquid hydrogen tank 70 by moving the battery 114. The control system 120 is substantially the same as previously described, except that there is no incoming line 124 from a generator 94 to the controller 122 as shown in FIG. 4. The aircraft 10 thus uses a hybrid aircraft power system 104 including a fuel cell 60, solar cells 112 and a flight power battery 114 to achieve stringent takeoff performance with improved endurance performance. Solar cells 112 offer an additional electrical energy source. Battery 114 offers the opportunity to store energy for no/low light conditions. A combination of the onboard power systems 62, 128 thus provide power for high power demand conditions including hover, high speed cruise, climb and operate in conditions where redundant power is required. Electrically powered motors 66, 96 drive the rotors 20, 22 eliminating the need for a complex mechanical drive system.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity or importance, but rather are used to distinguish one element from another. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A vertical take-off and landing aircraft comprising:
a wing structure including a wing;
a rotor operatively supported by the wing; and
a hybrid power system configured to drive the rotor, the hybrid power system including a first power system and a second power system, wherein a first energy source for the first power system is different than a second energy source for the second power system.

2. The vertical take-off and landing aircraft of claim 1, wherein the first power system includes a fuel cell.

3. The vertical take-off and landing aircraft of claim 2, further comprising a fuselage substantially centrally disposed with respect to the wing structure, wherein the first energy source is liquid hydrogen and disposed at least partially in the fuselage.

4. The vertical take-off and landing aircraft of claim 2, further comprising a nacelle disposed on the wing structure and supporting the rotor, wherein the fuel cell is disposed in the nacelle, and further comprising a fuel cell cooling system disposed in the nacelle.

5. The vertical take-off and landing aircraft of claim 2, wherein the second power system includes a fuel-burning engine.

6. The vertical take-off and landing aircraft of claim 5, wherein the second energy source is fuel disposed in a fuel tank at least partially supported on the wing structure.

7. The vertical take-off and landing aircraft of claim 1, wherein the second power system includes at least one solar panel disposed at least partially on the wing structure.

8. The vertical take-off and landing aircraft of claim 7, further comprising a battery configured to store solar energy captured by the at least one solar panel.

9. The vertical take-off and landing aircraft of claim 8, further comprising a fuselage substantially centrally located with respect to the wing structure, wherein the battery is disposed in the fuselage.

10. The vertical take-off and landing aircraft of claim 8, further comprising a nacelle disposed on the wing structure and supporting the rotor, wherein the battery is disposed within the nacelle.

11. The vertical take-off and landing aircraft of claim 1, further comprising a third power system, wherein a third energy source for the third power system is a different type of energy source than the first and second energy sources.

12. The vertical take-off and landing aircraft of claim 11, wherein the third power system includes at least one solar panel disposed at least partially on the wing structure.

13. The vertical take-off and landing aircraft of claim 1, wherein the wing is a first wing, and the rotor is a first rotor, and further comprising:
a fuselage;
a second wing, the first and second wings extending outwardly from opposite sides of the fuselage;
a first nacelle supported on the first wing, the first rotor operatively configured on the first nacelle;
a second nacelle supported on the second wing; and,
a second rotor operatively configured on the second nacelle.

14. The vertical take-off and landing aircraft of claim 13, wherein the first power system is at least partially disposed in the first nacelle, the second power system is at least partially disposed in the second nacelle, and at least one of the first and second energy sources is at least partially disposed in the fuselage.

15. The vertical take-off and landing aircraft of claim 13, further comprising a first gearbox of the first rotor, a second gearbox of the second rotor, and a cross-shaft connection between the first and second gearboxes, wherein, through the connection, power from the first power system is selectively transferrable to the first and second gearboxes and power from the second power system is selectively transferrable to the first and second gearboxes.

16. The vertical take-off and landing aircraft of claim 13, further comprising a first motor of the first rotor, a second motor of the second rotor, and an electrical connection between the first and second motors, wherein, through the electrical connection, power from the first power system is selectively transferrable to the first and second motors, and power from the second power system is selectively transferrable to the first and second motors.

17. The vertical take-off and landing aircraft of claim 13, further comprising a control system controlling transfer of power from the first and second power systems to the first and second rotors, wherein each of the first and second power systems provide power to the first and second rotors during a first mode of operation, and only the first power system provides power to the first and second rotors during a second mode of operation.

18. The vertical take-off and landing aircraft of claim 1, wherein the aircraft is operable in a first mode using both the first and second power systems and first and second energy sources, and in a second mode using only the second power system and second energy source.

19. The vertical take-off and landing aircraft of claim 18, wherein the first mode requires a higher power demand than the second mode, and the second energy source is at least one of solar energy and fuel for a fuel cell.

20. A method of controlling a vertical take-off and landing aircraft, the aircraft including a fuselage, a wing structure, a first rotor, and a second rotor, the method comprising:
determining whether the aircraft is operated in a first mode of operation requiring a first power demand or a second mode of operation requiring a second power demand lower than the first power demand;
operating each of a first and second power system to provide power to the first and second rotors during the first mode of operation, wherein the first and second power systems access different types of energy sources; and,
operating only the first power system to provide power to the first and second rotors during the second mode of operation.

21. The method of claim 20, wherein the first power system includes a fuel cell, and the fuselage stores liquid hydrogen for the fuel cell.

22. The method of claim 20, wherein the energy sources include any combination of solar energy, fossil fuel, and liquid hydrogen.

23. A vertical take-off and landing aircraft comprising:
a fuselage configured to store liquid hydrogen;
first and second wings extending outwardly from opposite sides of the fuselage;
a first nacelle supported on the first wing;
a first rotor on the first nacelle;
a second nacelle supported on the second wing;
a second rotor on the second nacelle; and,
a power system including a fuel cell in receipt of liquid hydrogen, and a motor driven by the fuel cell and operatively arranged to drive the first and second rotors.
